(19) United States
(12) Patent Application Publication
(10) Pub. No.: US 2014/0104774 A1
(43) Pub. Date: Apr. 17, 2014

(54) NOTEBOOK COMPUTER WITH AUDIO MODULE

(71) Applicant: HON HAI PRECISION INDUSTRY CO., LTD., New Taipei (TW)

(72) Inventors: SHIH-FENG LU, New Taipei (TW); SHIANG-HUI WEI, New Taipei (TW); CHIA-JUNG LIU, New Taipei (TW)

(21) Appl. No.: 13/910,275

(22) Filed: Jun. 5, 2013

(30) Foreign Application Priority Data
Oct. 15, 2012 (TW) 101137990

(51) Int. Cl. G06F 1/16

(52) U.S. Cl. CPC G06F 1/1688; G06F 1/1637
USPC 361/679.27

(57) ABSTRACT

A notebook computer comprises a base and a screen pivotally attached to the base. A groove is defined in the base for mounting an audio module. The audio module is pivotally mounted in the groove by a resilient member and configured to receive or send audio signals for users. The screen is rotatable between a closed position, where the screen covers the base module; and an open position, where the screen departs from the base module. When the screen is in the closed position, the audio module is in a first position, where the audio module is fully received in the groove, and the resilient member is compressed by the screen. When the screen is in the open position, the audio module is rotated to a second position, where the audio module protrudes out from the groove and the resilient member is released.

### BACKGROUND

1. Technical Field

The present disclosure relates to notebook computers, and more particularly to a notebook computer with an audio module.

2. Description of Related Art

A notebook computer comprises a base and a screen pivotably attached to the base. A speaker is mounted in the base. A plurality of sound emission holes is defined in the base for outputting audio signals produced by the speaker. However, the plurality of sound emission holes is defined in peripheral walls of the base and is not aimed directly at a user, which may limit the quality of the sound experience for the users.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled view of an embodiment of a notebook computer with an audio module.

FIG. 2 is an exploded view of the audio module and a resilient member of the notebook computer of FIG. 1.

FIG. 3 is a side view of the notebook computer of FIG. 1, showing the notebook computer in an open position.

FIG. 4 is a side view of the notebook computer of FIG. 1, showing the notebook computer in a closed position.

### DETAILED DESCRIPTION

The disclosure is illustrated by way of example and not by way of limitation in the figures of the accompanying drawings in which like references indicate similar elements. It should be noted thin references to “an” or “one” embodiment in this disclosure are not necessarily to the same embodiment, and such references mean “in least one.”

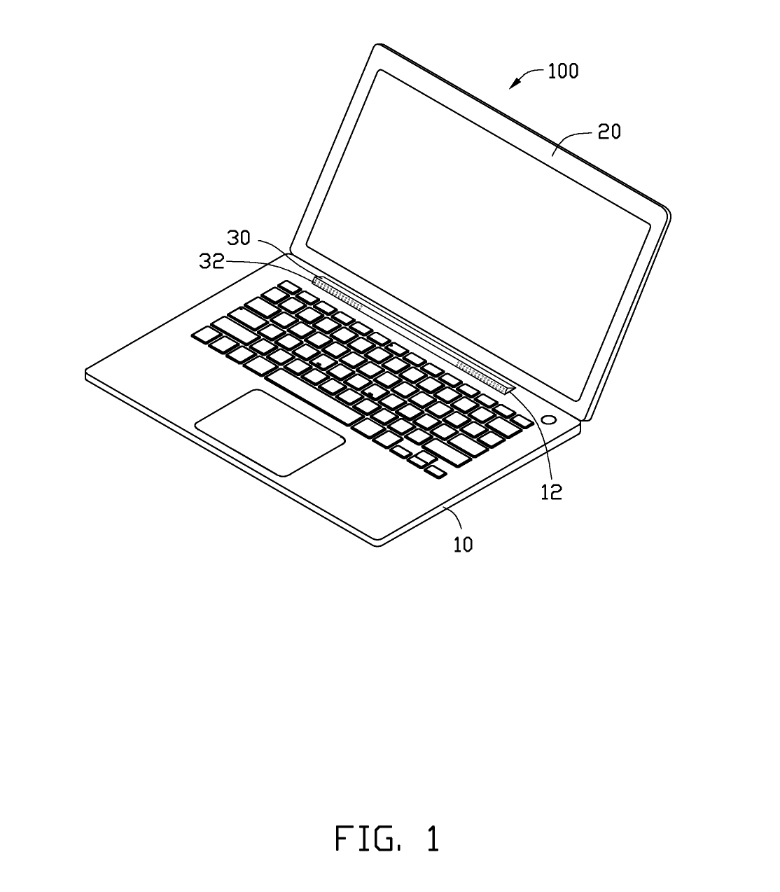

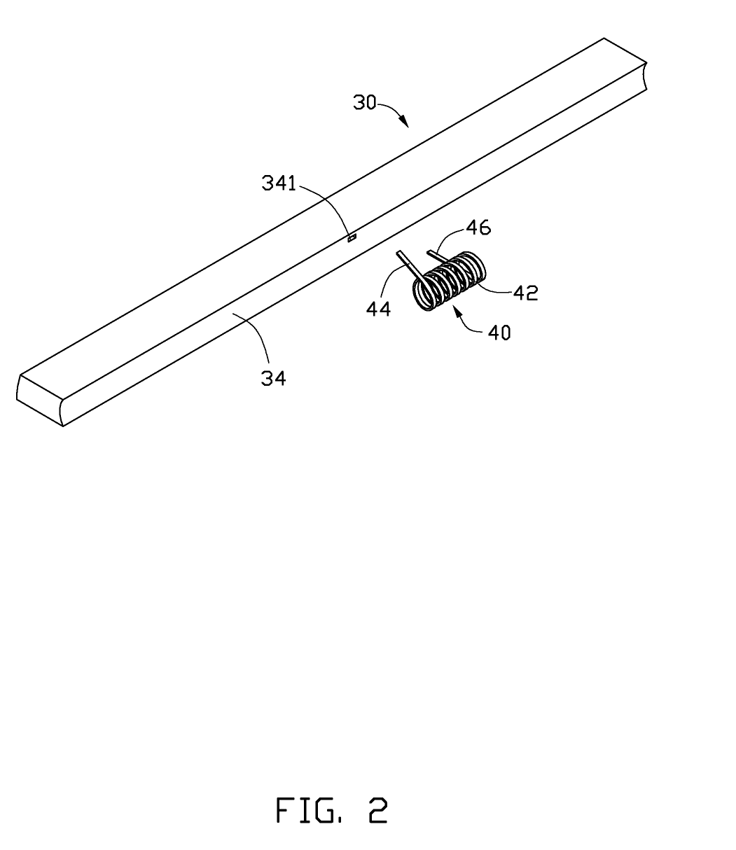

FIGS. 1 and 2 show an embodiment of a notebook computer comprising a base 10 and a screen 20 pivotably attached to the base 10. The base 10 comprises a keyboard portion and a processing unit. The screen 20 is in electrical communication with the processing unit.

A groove 12 is defined in the base 10 for receiving an audio module 30. The groove 12 is located adjacent to a pivot hinge between the base 10 and the screen 20. The audio module 30 can be pivotably mounted in the groove 12 by a resilient member 40. A plurality of holes 32 is defined in a front surface of the audio module 30 for receiving or outputting audio signals. The audio module 30 comprises an arc-shaped rear surface 34. A mounting hole 341 is defined in the arc-shaped rear surface 34. The audio module 30 further comprises a top surface and a base surface which are opposite and parallel to each other. In one embodiment, the resilient member 40 is a torque spring. The resilient member 40 comprises a spiral portion 42, a first arm 44 extending from a first end of the spiral portion 42, and a second arm 46 extending from a second end of the spiral portion 42. When the resilient member 40 is in a natural state, an angle between the first arm 44 and the second arm 46 is less than 90 degrees.

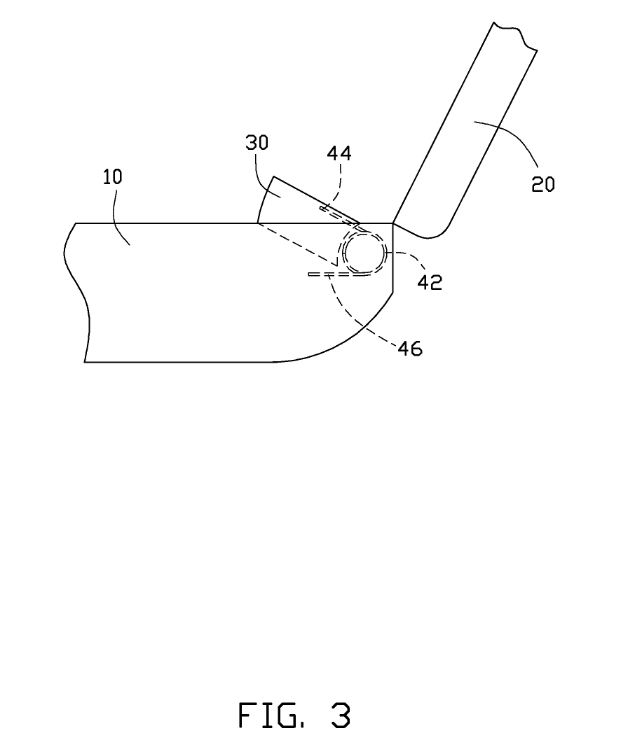

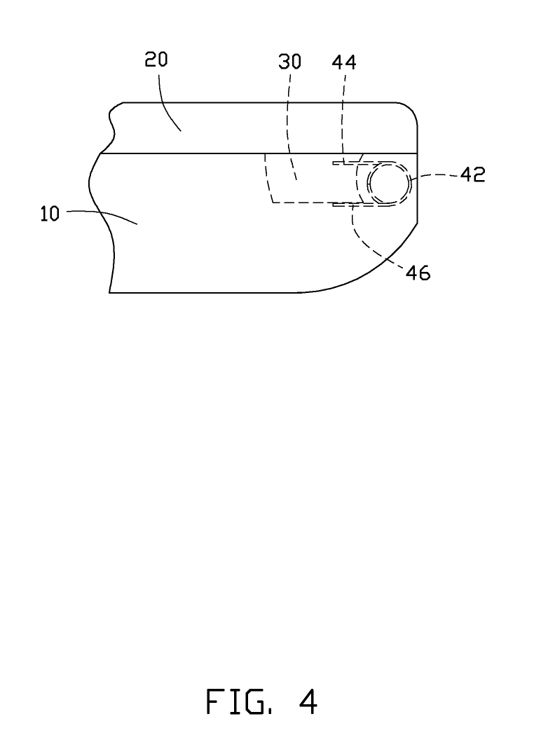

Referring to FIGS. 3 and 4, in assembly, the first arm 44 is mounted in the mounting hole 341. The second arm 46 is fixed to a bottom surface of the groove 12. The audio module 30 is pivotably mounted in the groove 12 by the resilient member 40.

When the screen 20 is rotated to an open position (see FIG. 3), the resilient member 40 is released. The second arm 46 is substantially parallel to a horizontal direction. The first arm 44 and the audio module 30 are located in an oblique position with respect to the horizontal direction. The audio module 30 partially protrudes from an upper surface of the base 10. The plurality of holes 32 is exposed and can transmit audio signals along oblique upward directions, which provides a direct path for audio signals from the audio module 30 to users.

When the screen 20 is rotated to a closed position (see FIG. 4), the resilient member 40 is compressed by the screen 20. Both the first arm 44 and the second arm 46 are substantially parallel to the horizontal direction. The audio module 30 is fully received in the groove 12. The top surface of the audio module 30 and the upper surface of the base 10 lie in the same horizontal plane.

In one embodiment, the notebook computer further comprises a latch structure mounted between the base 10 and the screen 20. When the screen 20 is rotated to the closed position, the latch structure secures the screen 20 to the base 10 and prevents the screen 20 rotating away from the closed position by urging of the resilient member 40.

It is to be understood, however, thin even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A notebook computer comprising:
a base comprising a groove;
a resilient member;
an audio module pivotally mounted in the groove with the resilient member and configured to receive or send audio signals;
a screen pivotally attached to the base, wherein the screen is rotatable between a closed position and an open position; the closed position is when the screen covers the base module; the open position is when the screen is turned away from the base module; when the screen is in the closed position, the audio module is in a first position; in the first position, the audio module is fully received in the groove, and the resilient member is compressed by the screen; when the screen is in the open position, the audio module is rotated to a second position; in the second position, the audio module protrudes out from the groove, and the resilient member is released.

2. The notebook computer of claim 1, wherein the audio module comprises a plurality of holes defined in a front surface of the audio module, the plurality of holes allow audio signals to pass through; when the audio module is in the second position, the front surface of the audio module is exposed and oblique relative to the base.

3. The notebook computer of claim 1, wherein when the audio module is in the first position, a top surface of the audio module and an upper surface of the base lie substantially in the same horizontal plane; when the audio module is in the second position, the top surface of the audio module is oblique relative to the upper surface of the base.

4. The notebook computer of claim 1, wherein the resilient member is a torque spring.

5. The notebook computer of claim 4, wherein the torque spring comprises a spiral portion, a first arm extending from a first end of the spiral portion, and a second arm extending from a second end of the spiral portion; the first arm is attached to the audio module, and the second arm is fixed to a base surface of the groove.

6. The notebook computer of claim 5, wherein the torque spring has a first deformation degree when the audio module is in the first position, and has a second deformation degree when the audio module is in the second position; the first deformation degree is greater than the second deformation degree.

7. The notebook computer of claim 6, where when the audio module is in the first position, the first arm is substantially parallel to the second arm; when the audio module is in the second position, the first arm is oblique relative to the second arm.

8. The notebook computer of claim 7, wherein a bottom surface of the audio module is in contact with the second arm when the audio module is in the first position, and the bottom surface of the audio module is away from the second arm.

9. The notebook computer of claim 5, wherein the audio module comprises an arc-shaped rear surface, a mounting hole is defined in the arc-shaped rear surface, and the first arm is mounted in the mounting hole.

10. The notebook computer of claim 1, wherein the groove is located adjacent to the screen.

11. A notebook computer comprising:
a base, the base defining a groove;
a resilient member;
an audio module connected to the resilient member and received in the groove, the audio module comprising a front surface and a plurality of holes defined in the front surface for allowing audio signals to pass through;
a screen pivotally attached to the base, wherein the screen is rotatable between a closed position and an open position; in the closed position, the screen covers the base module; in the open position, the screen is turned from the base module;
wherein when the screen is in the closed position, the audio module is in a first position; in the first position, the audio module is fully received in the groove, and the resilient member is compressed; when the screen is in the open position, the audio module is moved to a second position; in the second position, the front wall protrudes out from the groove and is located in a slanting direction relative to the base; and the resilient member is released.

12. The notebook computer of claim 11, wherein a rotation direction of the audio module is the same as the rotation direction of the screen.

13. The notebook computer of claim 11, wherein when the audio module is in the first position, a top surface of the audio module and an upper surface of the base lie substantially in the same horizontal plane; when the audio module is in the second position, the top surface of the audio module is oblique relative to the upper surface of the base.

14. The notebook computer of claim 11, wherein the resilient member is a torque spring.

15. The notebook computer of claim 14, wherein the torque spring comprises a spiral portion, a first arm extending from a first end of the spiral portion, and a second arm extending from a second end of the spiral portion; the first arm is attached to the audio module, and the second arm is fixed to a base surface of the groove.

16. The notebook computer of claim 15, wherein the torque spring has a first deformation degree when the audio module is in the first position, and has a second deformation degree when the audio module is in the second position; the first deformation degree is greater than the second deformation degree.

17. The notebook computer of claim 16, where when the audio module is in the first position, the first arm is substantially parallel to the second arm; and when the audio module is in the second position, the first arm is oblique relative to the second arm.

18. The notebook computer of claim 17, wherein a bottom surface of the audio module is in contact with the second arm when the audio module is in the first position, and the bottom surface of the audio module is away from the second arm.

19. The notebook computer of claim 15, wherein the audio module comprises an arc-shaped rear surface, a mounting hole is defined in the arc-shaped rear surface, and the first arm is mounted in the mounting hole.

20. The notebook computer of claim 11, wherein the groove is located adjacent to the screen.
